(19) United States
(12) Patent Application Publication
(10) Pub. No.: US 2012/0282427 A1
(43) Pub. Date: Nov. 8, 2012

(54) Ultraviolet-Curable Resin Composition For Optical Disc And Cured Product Thereof

(75) Inventors: Hiroki Tsutsumi, Kita-ku (JP); Daisuke Kobayashi, Kita-ku (JP); Masahiro Naitou, Kita-ku (JP); Yuichiro Matsuo, Kita-ku (JP); Jun Kidoba, Kita-ku (JP); Hayato Motohashi, Kita-ku (JP)

(73) Assignee: NIPPONKAYAKU KABUSHIKIKAISHA, Chiyoda-ku, Tokyo (JP)

(21) Appl. No.: 13/511,814

(22) PCT Filed: Nov. 29, 2010
(86) PCT No.: PCT/JP2010/006927

§ 371 Date: May 24, 2012

(30) Foreign Application Priority Data
Dec. 2, 2009 (JP) 2009-274048

(51) Int. Cl. B32B 3/02; C08G 18/75; B29C 35/08

(52) U.S. Cl. 428/64.4; 264/494; 522/174

(57) ABSTRACT

The present invention relates to a multilayer optical disc having, as an intermediate layer, a cured product layer of an ultraviolet-curable resin composition containing an urethane (meth)acrylate (A) having one or two (meth)acrylate groups in one molecule obtained by reacting a monofunctional or bifunctional organic isocyanate (a) having a molecular weight of 350 or less with a mono(meth)acrylate (b) having a hydroxy group, a (meth)acrylate monomer (B) and a photopolymerization initiator (C), where the content of the (A) component is 5 to less than 40% by weight based on the total amount of the (A) component and the (B) component and the rest is (B), and to a resin composition for said cured product layer. Said resin composition has characteristics that it has a smaller variation in warp before and after curing the above-described resin composition when it is formed into the above-described intermediate layer, it is suitable for shaping a substrate by a 2P method because it allows good detachability of a stamper after curing, it is excellent in mass production of multilayer optical discs, and that the obtained optical disc therefrom has a smaller variation in warp before and after durability test under high temperature and high humidity.

### TECHNICAL FIELD

The present invention relates to an ultraviolet-curable resin composition for a multilayer optical disc, a cured product obtained by irradiating ultraviolet rays and the like onto said composition, and an optical disc having said cured product as a transparent resin intermediate layer. The present invention particularly relates to an ultraviolet-curable resin composition having a smaller variation in warp in curing and after being placed under high temperature and high humidity, being excellent in detachability from a stamper, and being useful for efficiently producing a next generation high density optical disc.

### BACKGROUND ART

Recently, there is a significant need for increasing the capacity of an optical disc. The techniques for increasing the recording capacity of an optical disc include wavelength-shortening of recording/reproducing beam, NA (numerical aperture)-increasing of objective lens in a recording/reproducing beam irradiation optical system, multi-layering of a recording layer, and the like. Among them, capacity-increasing by multi-layering of a recording layer allow capacity-increasing at low cost compared with wavelength-shortening and NA-increasing.

For example, a DVD disc having two recording layers has a structure where the two recording layers are laminated via a transparent resin intermediate layer. Specifically, it has a structure where a 0.6 mm first transparent resin substrate, a first recording layer, a first semitransparent reflecting layer, an adhesive layer, a transparent resin intermediate layer, a second recording layer, a second reflecting layer, an adhesive layer and a 0.6 mm second transparent resin substrate are laminated in this order from the incident direction of recording/reproducing beam.

The method of forming a transparent resin intermediate layer in this case includes a method where a transparent resin intermediate layer with a recess/protrusion pattern transferred to the surface of an ultraviolet-curable resin composition is formed by coating an ultraviolet-curable resin composition forming a transparent resin intermediate layer onto an adhesive layer formed on a first semitransparent reflecting layer, placing a transparent resin stamper having a recess/protrusion pattern such as a guide groove for guiding a recording/reproducing beam followed by spin coating, curing an ultraviolet-curable resin composition layer, and then detaching said stamper; or a method where a transparent resin intermediate layer with a recess/protrusion pattern transferred is formed by forming a cured product layer of an ultraviolet-curable resin composition on a transparent resin stamper having a recess/protrusion pattern, placing a transparent resin stamper with said cured product layer on a resin coated on a first semitransparent reflecting layer for forming an adhesive layer, spin coating to form a adhesive layer, curing said adhesive layer, and then detaching the transparent resin stamper from the cured product layer of said ultraviolet-curable resin composition (transfer method).

For a Blu-ray disc exclusive for reading, for example, a pit-shaped recording pattern is transferred on one side of a polycarbonate substrate having a diameter of 120 mm and a thickness of 1.1 mm, a first reflective film to be a first recording layer, for example, a silver alloy reflective film is deposited on the surface of this substrate, a transparent resin intermediate layer with a pit-shaped recording pattern transferred is further formed on the first reflective film via an adhesive layer, and a second reflective film to be a second recording layer, for example, a silver alloy reflective film is deposited on this transparent resin intermediate layer. A procedure is proposed in which a silver alloy reflective film is deposited in vacuum by, for example, a sputtering method.

A recording-type Blu-ray disc has, for example, a structure where a pit-shaped recording pattern is transferred to one side of the substrate of polycarbonate having a diameter of 120 mm and a thickness of 1.1 mm; a first reflective film, a first dielectric layer, a first recording layer and a second dielectric layer are laminated on the surface of this substrate; and an adhesive layer, a transparent resin intermediate layer, a second reflective film, a third dielectric layer, a second recording layer and a fourth dielectric layer are further laminated in this order.

In these cases, a transparent resin intermediate layer is usually formed after an ultraviolet-curable resin composition forming a transparent resin intermediate layer is coated on an adhesive layer formed on the first reflective film or the second dielectric layer and pressed on a transparent resin stamper with a recess/protrusion pattern such as a guide groove for guiding a recording/reproducing beam, the ultraviolet-curable resin composition is cured, then said stamper is detached, and the recess/protrusions are transferred to the surface of the ultraviolet-curable resin composition (transfer method).

Usually, a second reflective film is formed on the recess/protrusion-side of a transparent resin intermediate layer, and on the opposite side, a first reflective film is adhered for a Blu-ray disc exclusive for reading and a second dielectric layer is adhered for a recording-type Blu-ray disc, via an adhesive layer.

Generally, said transfer method is referred to as 2P (Photo Polymerization) method, and the ultraviolet-curable resin composition to be used is referred to as 2P resin (or 2P agent).

The transparent resin to be used for the transparent resin stamper includes acrylic-based resins, methacryl-based resins, polycarbonate resins, polyolefin-based resins (particularly amorphous polyolefin), polyester-based resins, polystyrene resins, epoxy resins and the like. Among them, amorphous polyolefin is preferable in terms of detachability after curing a 2P resin, low moisture absorbency, shape stability and the like, and polycarbonate resins are preferable in terms of material cost. A manufacturing method of a multilayer optical recording medium which allows easy detachment even when a stamper made of inexpensive polycarbonate is used for the purpose of reducing cost, improves yield, and provides an optical recording medium having a plurality of recording layers has been proposed, and also a resin suitable for said manufacturing method has been developed (Patent Literature 1).

Generally, a polycarbonate resin is used for a 0.6 mm resin substrate of a DVD and for a 1.1 mm resin substrate of a Blu-ray disc. When a polycarbonate resin is used as a transparent resin stamper, an ultraviolet-curable resin different from the 2P resin is used in an adhesive layer for a first reflective film or a second dielectric layer on the resin substrate side, so that a resin stamper made of polycarbonate can be easily detached from the 2P resin layer after curing.

Poor detachability from a transparent resin stamper results in that some of a transparent resin intermediate layer is detached together with the transparent resin stamper, leading to a defect generated on the transparent resin intermediate layer. Poor transcribability of a recess/protrusion pattern from a transparent resin stamper to a transparent resin intermediate layer results in that an error is generated in recording/reproducing. Further, if warping of an optical disc after ultraviolet curing is large, a recording layer or a reflecting layer cannot be uniformly formed on the recess/protrusion side of the formed transparent resin intermediate layer, and also a second substrate cannot be bonded in the case of DVD or a 0.1 mm light transmitting layer cannot be uniformly formed in the case of Blu-ray disc. In addition, warping of the optical disc becomes larger when stored under high temperature and high humidity and therefore the recess/protrusion pattern formed on the transparent resin intermediate layer is deformed, resulting in inequality of recording properties (for example, jitter property) of the first and second recording layers.

As for 2P resins described in Patent Literatures 2 to 5, a recess/protrusion pattern is formed on a resin layer formed on a glass substrate using a stamper made of metal, and recess/protrusion pattern formation by a transparent resin stamper is not described. In addition, Patent Literatures 6 to 9 describe 2P resins but do not describe the resin of the present invention. Patent Literature 10 describes an ultraviolet curable composition to be used for a light transmitting layer in an optical disc but does not describe detachability of a cured product of said ultraviolet curable composition from a transparent resin stamper.

### RELATED TECHNICAL LITERATURE

### Patent Literature

Patent Literature 1: Japanese Patent Laid-Open No. 2007-224057 A
Patent Literature 2: Japanese Patent Laid-Open No. H5-59139 A
Patent Literature 3: Japanese Patent Laid-Open No. H5-132534 A
Patent Literature 4: Japanese Patent Laid-Open No. H5-140254 A
Patent Literature 5: Japanese Patent Laid-Open No. H5-132506 A
Patent Literature 6: Japanese Patent Laid-Open No. 2003-331463 A
Patent Literature 7: Japanese Patent Laid-Open No. 2004-288242 A
Patent Literature 8: Japanese Patent Laid-Open No. 2004-288264 A
Patent Literature 9: Japanese Patent Laid-Open No. 2005-332564 A
Patent Literature 10: Japanese Patent Laid-Open No. 2009-158026 A

### SUMMARY OF THE INVENTION

### Problems to be Solved by the Invention

Usually, an ultraviolet-curable resin composition to be used as a 2P agent for multilayer discs is required to have high detachability from a stamper after forming a recess/protrusion pattern in a stamper and after curing. Poor detachability from a stamper causes such problems that some of said cured product is attached to the stamper and therefore a reflective film or a dielectric layer is not adhered to the deficient part or that an error is generated in recording/reproducing due to deficiency of a recess/protrusion pattern, leading to decrease in production efficiency of optical discs. On the other hand, even a resin composition having high detachability from a stamper poses such problems that a reading error of optical disc information is generated if the warp variation is large in curing a resin composition or before and after an optical disc having a cured product layer of said resin composition is placed under high temperature and high humidity.

Therefore, it is an object of the present invention to provide a resin composition having excellent detachment from a stamper, particularly from a transparent resin stamper made of polycarbonate, and a smaller variation in warp before and after an optical disc obtained therefrom is even placed under high temperature and high humidity, and to provide a multilayer optical disc having a cured product layer thereof.

### Means of Solving the Problems

The present inventors have found that a cured product of an ultraviolet-curable resin composition (also referred to as ultraviolet-curing resin composition or photocurable resin composition) containing an urethane (meth)acrylate having one or two (meth)acrylate groups in one molecule obtained by reacting a monofunctional or bifunctional organic isocyanate having a molecular weight of 350 or less with a (meth)acrylate having a hydroxy group and containing a (meth)acrylate monomer is excellent in detachability from a stamper, has a smaller variation in warp of optical disc in curing said resin composition, and further allows a multilayer optical disc obtained therefrom to have a smaller variation in warp before and after it is even placed under high temperature and high humidity.

The present invention relates to the following (1) to (19).
(1)

A multilayer optical disc having a cured product layer of an ultraviolet-curable resin composition containing an urethane (meth)acrylate (A) having one or two (meth)acrylate groups in one molecule obtained by reacting a monofunctional or bifunctional organic isocyanate (a) having a molecular weight of 350 or less with a mono(meth)acrylate (b) having a hydroxy group, a (meth)acrylate monomer (B) and a photopolymerization initiator (C), where the content of the (A) component is less than 5 to 40% by weight based on the total amount of the (A) component and the (B) component, and the rest is (B).
(2)

The multilayer optical disc according to the above-described (1), wherein the organic isocyanate (a) is at least one kind selected from the group consisting of a C6 to C10 alicyclic mono- or di-isocyanate, a C6 to C10 aromatic ring mono- or di-isocyanate, hexamethylene diisocyanate and a (meth)acryloyloxy C2 to C4 alkyl isocyanate.
(3)

The multilayer optical disc according to the above-described (1), wherein the organic isocyanate (a) is at least one kind selected from the group consisting of isophorone diisocyanate, hexamethylene diisocyanate and (meth)acryloyloxyethyl isocyanate.
(4)

The multilayer optical disc according to any one of the above-described (1) to (3), wherein the mono(meth)acrylate (b) having a hydroxy group is at least one kind selected from the group consisting of hydroxyethyl (meth)acrylate, hydroxypropyl (meth)acrylate, hydroxybutyl (meth)acrylate, and (meth)acrylic acid adducts of polypropylene glycol diglycidyl ether or polyethylene glycol diglycidyl ether.
(5)

The multilayer optical disc according to any one of the above-described (1) to (4), wherein the (meth)acrylate monomer (B) is a compound having one or two (meth)acrylate groups in one molecule.
(6)

The multilayer optical disc according to the above-described (5), wherein the (meth)acrylate monomer (B) is at least one kind selected from the group consisting of isobornyl (meth)acrylate, isostearyl (meth)acrylate, dicyclopentenyloxyethyl (meth)acrylate, neopentyl glycol di(meth)acrylate, propylene oxide-modified neopentyl glycol di(meth)acrylate, tricyclodecanedimethanol di(meth)acrylate and hydroxypivalaldehyde-modified trimethylolpropane di(meth)acrylate.
(7)

The multilayer optical disc according to any one of the above-described (1) to (6), wherein the total content of the urethane (meth)acrylate (A) and the (meth)acrylate monomer (B) is 90 to 99% by weight and the content of the photopolymerization initiator (C) is 1 to 10% by weight, based on the total amount of the resin composition.
(8)

The multilayer optical disc according to any one of the above-described (1) to (7), wherein 5 to 35% by weight of the urethane (meth)acrylate (A), 55 to 90% by weight of the (meth)acrylate monomer (B) and 1 to 10% by weight of the photopolymerization initiator (C) are contained based on the total amount of the resin composition.
(9)

The multilayer optical disc according to the above-described (1) or (7), wherein:
the organic isocyanate (a) is at least one kind selected from the group consisting of isophorone diisocyanate, hexamethylene diisocyanate and (meth)acryloyloxyethyl isocyanate;
the mono(meth)acrylate (b) having a hydroxy group is at least one kind selected from the group consisting of hydroxyethyl (meth)acrylate, hydroxypropyl (meth)acrylate and hydroxybutyl (meth)acrylate;
the (meth)acrylate monomer (B) is at least one kind selected from the group consisting of isobornyl (meth)acrylate, tricyclodecanedimethanol di(meth)acrylate, dicyclopentenyloxyethyl (meth)acrylate and hydroxypivalaldehyde-modified trimethylolpropane di(meth)acrylate; and
5 to 35% by weight of the urethane (meth)acrylate (A), 55 to 90% by weight of the (meth)acrylate monomer (B) and 1 to 10% by weight of the photopolymerization initiator (C) are contained based on the total amount of the resin composition.
(10)

The multilayer optical disc according to claim 1, wherein at least one kind of (B-1) selected from the group consisting of isobornyl (meth)acrylate, tricyclodecanedimethanol di(meth)acrylate and hydroxypivalaldehyde-modified trimethylolpropane di(meth)acrylate is contained as the(meth)acrylate monomer (B), and the total content of the urethane (meth)acrylate (A) and said (B-1) component is 80 to 100% by weight based on the total amount of the (A) component and the (B) component.
(11)

The multilayer optical disc according to any one of the above-described (1) to (10) and (19), wherein the cured product layer is an intermediate layer of the multilayer optical disc.
(12)

A method for manufacturing a multilayer optical disc, comprising a process in which:
(i) the resin composition according to any one of the above-described (1) to (10) and (19) is directly coated either on a reflecting layer or a dielectric layer laminated on a transparent resin substrate or on a transparent resin stamper, the both are bonded, and then said resin composition is cured by irradiating ultraviolet rays to form an intermediate layer; or
(ii) the resin composition according to any one of the above-described (1) to (10) and (19) is directly coated on a transparent resin stamper, subsequently said resin layer is cured by irradiating ultraviolet rays to said resin layer, said cured product layer and the reflecting layer or the dielectric layer laminated on the transparent resin substrate are bonded via an adhesive layer to form an intermediate layer;
and then the transparent resin stamper is detached from the intermediate layer, a coloring matter layer and a reflecting layer, or a dielectric layer, as a second layer, is directly formed on the intermediate layer, and in addition, a recording layer and a dielectric layer are formed in the case of a dielectric layer.
(13)

Use of the ultraviolet-curable resin composition according to any one of the above-described (1) to (10) and (19) for forming an intermediate layer in a multilayer optical disc.
(14)

An ultraviolet-curable resin composition for a multilayer optical disc, wherein an urethane (meth)acrylate (A) having one or two (meth)acrylate groups in one molecule obtained by reacting a monofunctional or bifunctional organic isocyanate (a) having a molecular weight of 350 or less with a mono(meth)acrylate (b) having a hydroxy group, a (meth)acrylate monomer (B) and a photopolymerization initiator (C) are contained, the content of (A) is less than 5 to 40% by weight based on the total amount of (A) and (B), and the rest is (B).
(15)

The ultraviolet-curable resin composition for a multilayer optical disc according to the above-described (14), wherein the (meth)acrylate monomer (B) is a compound having one or two (meth)acrylate groups in one molecule.
(16)

The ultraviolet-curable resin composition for a multilayer optical disc according to the above-described (14) or (15), wherein:
the organic isocyanate (a) is at least one kind selected from the group consisting of isophorone diisocyanate, hexamethylene diisocyanate and (meth)acryloyloxyethyl isocyanate;
the mono(meth)acrylate (b) having a hydroxy group is at least one kind selected from the group consisting of hydroxyethyl (meth)acrylate, hydroxypropyl (meth)acrylate and hydroxybutyl (meth)acrylate;
the (meth)acrylate monomer (B) is at least one kind selected from the group consisting of isobornyl (meth)acrylate, tricyclodecanedimethanol di(meth)acrylate, dicyclopentenyloxyethyl (meth)acrylate and hydroxypivalaldehyde-modified trimethylolpropane di(meth)acrylate; and
5 to 35% by weight of the urethane (meth)acrylate (A), 55 to 90% by weight of the (meth)acrylate monomer (B) and 1 to 10% by weight of the photopolymerization initiator (C) are contained based on the total amount of the resin composition.
(17)

The ultraviolet-curable resin composition for a multilayer optical disc according to the above-described (14) to (16), wherein at least one kind of (B-1) selected from the group consisting of isobornyl (meth)acrylate, tricyclodecanedimethanol di(meth)acrylate and hydroxypivalaldehyde-modified trimethylolpropane di(meth)acrylate is contained as the (meth)acrylate monomer (B), and the total content of the urethane (meth)acrylate (A) and said (B-1) component is 80 to 100% by weight based on the total amount of the (A) component and the (B) component.
(18)

The ultraviolet-curable resin composition for a multilayer optical disc according to the above-described (17), wherein at least two kinds are contained as said (B-1) component, one kind is hydroxypivalaldehyde-modified trimethylolpropane di(meth)acrylate, and the total content of said two kinds is 90 to 100% by weight based on the total amount of the (meth)acrylate monomer (B).
(19)

An multilayer optical disc having a cured product layer of the ultraviolet-curable resin composition for a multilayer optical disc according to the above-described (18).

### Effect of the Invention

The cured product of the ultraviolet-curable resin composition of the present invention is excellent in detachability from a stamper, particularly detachability from a transparent resin stamper made of polycarbonate, and has a smaller variation in warp of optical disc in curing said resin composition. In addition, the multilayer optical disc having the cured product layer of said resin composition as an intermediate layer has a characteristic that the variation in warp is smaller before and after being even placed under high temperature and high humidity. Further, the above-described cured product layer has also a characteristic that the transmittance ratio of blue laser beam is high. Therefore, said resin composition is useful as a 2P agent for a multilayer optical disc.

Furthermore, the ultraviolet-curable resin composition of the present invention is adhered directly to a reflective film or a dielectric layer by curing, so there is no necessity to provide an adhesive layer on the reflective film or the dielectric layer for detaching a stamper and it is possible to form a transparent resin intermediate layer with one liquid and without an adhesive layer of a multilayer optical disc.

### MODE FOR CARRYING OUT THE INVENTION

The ultraviolet-curable resin composition for a multilayer optical disc of the present invention (hereinafter, also referred to as “the ultraviolet-curable resin composition of the present invention” or more simply “the resin composition of the present invention”) contains an urethane (meth)acrylate (A) having one or two (meth)acrylate groups in one molecule obtained by reacting a monofunctional or bifunctional organic isocyanate (a) having a molecular weight of 350 or less with a mono(meth)acrylate (b) having a hydroxy group, a (meth)acrylate monomer (B) and a photopolymerization initiator (C).

In the present invention, the term “(meth)acrylate” is used as meaning either or both of acrylate or methacrylate.

In the present description, “%”, “part(s)” and the like mean “%”, “by weight” and “part(s) by weight” respectively unless otherwise specified.

As the monofunctional or bifunctional organic isocyanate (a) having a molecular weight of 350 or less to be used in manufacturing the urethane (meth)acrylate (A) used in the present invention, any can be used without particular limitation as long as it is a known compound having at least one isocyanate group and a molecular weight of 350 or less and being monofunctional or bifunctional. It is preferably a compound having one or two isocyanate groups in one molecule.

The molecular weight of said organic isocyanate (a) is 80 to 350 and preferably 100 to 300.

Preferable said organic isocyanate (a) can include a 06 to 010 alicyclic mono- or di-isocyanate, a C6 to C10 aromatic ring mono- or di-isocyanate, hexamethylene diisocyanate, a (meth)acryloyloxy C2 to C4 alkyl isocyanate or the like.

The C6 to C10 alicyclic mono- or di-isocyanate may be a compound having one or two isocyanate groups in a C6 to C10 aliphatic ring, and said aliphatic ring may have one to three C1 to C3 alkyl groups.

The C6 to C10 aromatic ring mono- or di-isocyanate may be a compound having an aromatic ring such as a benzene ring, a naphthalene ring or the like where said aromatic ring (preferably, benzene ring) may be one or two which may be bound to a methylene group, and said aromatic ring has one or two isocyanates. Said aromatic ring may have one to three C1 to C3 alkyl groups. Said aromatic ring is preferably a benzene ring.

Specific examples of preferable said organic isocyanate (a) can include, for example, isophorone diisocyanate, dicyclopentanyl isocyanate or the like as the C6 to C10 alicyclic mono- or di-isocyanate; tolylene diisocyanate, xylene diisocyanate, diphenylmethane-4,4′-diisocyanate or the like as the C6 to C10 aromatic ring mono- or di-isocyanate; (meth)acryloyloxyethyl isocyanate or the like as the (meth)acryloyloxy C2 to C4 alkyl isocyanate; and in addition, hexamethylene diisocyanate.

These as the organic isocyanate (a) can be used alone or as a mixture of two or more kinds thereof at an arbitrary ratio.

The above-described organic isocyanate (a) is preferably at least one kind selected from the group consisting of isophorone diisocyanate, hexamethylene diisocyanate and (meth)acryloyloxyethyl isocyanate and more preferably isophorone diisocyanate.

As the mono(meth)acrylate (b) having a hydroxy group to be used in manufacturing said urethane (meth)acrylate (A), a mono(meth)acrylate compound having a known hydroxy group can be used without particular limitation, and a (meth)acrylate compound having one or two hydroxy groups in one molecule is preferable.

Preferable mono(meth)acrylate (b) having a hydroxy group includes a C2 to C10 aliphatic mono(meth)acrylate substituted by one or two hydroxy groups, a mono (meth)acrylic acid adduct of poly C2 to C4 alkylene (preferably, C2 to C3 alkylene) glycol, and the like. Among them, a C2 to C10 aliphatic mono(meth)acrylate substituted by one or two hydroxy groups is preferable, more preferable is a C2 to C6 aliphatic mono(meth)acrylate substituted by one hydroxy group, and further preferable is a hydroxy C2-C4 alkyl (meth)acrylate. The aliphatic group here may be cyclic or chain, and it is preferably an alkyl group.

Preferable specific examples of the mono(meth)acrylate (b) having a hydroxy group include, for example, hydroxyethyl (meth)acrylate, hydroxypropyl (meth)acrylate or hydroxybutyl (meth)acrylate as the C2 to C10 aliphatic (meth)acrylate substituted by one hydroxy group; (meth)acrylic acid adducts of polypropylene glycol diglycidyl ether or polyethylene glycol diglycidyl ether as the mono (meth)acrylic acid adduct of poly C2 to C4 alkylene (preferably, C2 to C3 alkylene) glycol; and the like. Among them, more preferable are hydroxyethyl (meth)acrylate, hydroxypropyl (meth)acrylate and hydroxybutyl (meth)acrylate.

The above-described ones as the mono(meth)acrylate (b) having a hydroxy group may be used alone or as a mixture of two or more kinds thereof at an arbitrary ratio.

The reaction of the above-described organic isocyanate (a) with the mono(meth)acrylate (b) having a hydroxy group is carried out as follows. That is, they are mixed so that the isocyanate group of the organic isocyanate (a) is 0.5 to 1.1 equivalent and preferably 0.8 to 1.0 equivalent per 1 equivalent of the hydroxy group in the mono(meth)acrylate (b) having a hydroxy group, and thus the intended urethane (meth)acrylate (A) is obtained. The reaction temperature in this reaction is usually room temperature to 100° C. and preferably 50° C. to 90° C. In order to prevent gelation due to radical polymerization in this reaction, it is preferable to add a polymerization inhibitor to the reactant. As a reaction solvent, an organic solvent having no effect on said reaction and dissolving the reactant may be used, but it is preferred to carry out the reaction without a solvent.

Specific examples of said polymerization inhibitor include hydroquinone, hydroquinone monomethyl ether, p-methoxyphenol (methoquinone), p-benzoquinone, dibutylhydroxytoluene and the like. The addition amount of the polymerization inhibitor is preferably 10 to 2000 ppm, more preferably 50 to 1500 ppm and further preferably 500 to 1500 ppm, based on said reactant.

In addition, a catalyst can be used in order to facilitate the above-described reaction. Said catalyst includes a basic catalyst and an acidic catalyst. The basic catalyst includes, for example, amines such as pyridine, pyrrole, triethylamine, diethyl amine, dibutylamine and ammonia, and phosphines such as tributylphosphine. The acidic catalyst includes, for example, naphthenic acid copper, naphthenic acid cobalt, naphthenic acid zinc, metal alkoxides (such as tributoxyaluminum, trititanium tetrabutoxide and zirconium tetrabutoxide), Lewis acids (such as aluminum chloride), tin compounds (such as 2-ethylhexanetin, octyltin trilaurate, octyltin diacetate and dibutyltin laurate) and the like. The addition amount of said catalyst is 50 to 1000 ppm in a reaction solution.

The preferable urethane (meth)acrylate (A) having one or two (meth)acrylate groups in one molecule obtained in the above-described reaction is preferably an urethane (meth)acrylate obtained by reacting the above-described preferable or more preferable organic isocyanate with a preferable or more preferable mono(meth)acrylate (b) having a hydroxy group.

Examples of the preferable urethane (meth)acrylate to be used in the present invention will be listed in the below-described (i) to (v).
(i) An urethane (meth)acrylate obtained by reacting at least one kind selected from the group consisting of a C6 to C10 alicyclic mono- or di-isocyanate, a C6 to C10 aromatic ring mono- or di-isocyanate, hexamethylene diisocyanate and a (meth)acryloyloxy C2 to C4 alkyl isocyanate and more preferably at least one kind selected from the group consisting of isophorone diisocyanate, hexamethylene diisocyanate and (meth)acryloyloxyethyl isocyanate as the above organic isocyanate (a) with at least one kind selected from the group consisting of a C2 to C10 aliphatic (meth)acrylate substituted by one or two hydroxy groups and a (meth)acrylic acid adduct of polypropylene glycol diglycidyl ether or polyethylene glycol diglycidyl ether as the mono(meth)acrylate (b) having a hydroxy group.
(ii) An urethane (meth)acrylate obtained using a C2 to C6 aliphatic (meth)acrylate substituted by one hydroxy group as the mono(meth)acrylate (b) having a hydroxy group in the above-described (i).
(iii) An urethane (meth)acrylate obtained using at least one kind selected from the group consisting of hydroxyethyl (meth)acrylate, hydroxypropyl (meth)acrylate, hydroxybutyl (meth)acrylate and (meth)acrylic acid adducts of polypropylene glycol diglycidyl ether or polyethylene glycol diglycidyl ether as the mono(meth)acrylate (b) having a hydroxy group in the above-described (i).
(iv) An urethane (meth)acrylate obtained using at least one kind selected from the group consisting of hydroxyethyl (meth)acrylate, hydroxypropyl (meth)acrylate and hydroxybutyl (meth)acrylate as the mono(meth)acrylate (b) having a hydroxy group in the above-described (iii).
(v) An urethane (meth)acrylate obtained using isophorone diisocyanate as the above organic isocyanate (a) in the above-described (i) to (iv).

The urethane (meth)acrylate (A) having one or two (meth)acrylate groups in one molecule obtained by the above-described reaction can be used as a mixture of one kind or two or more kinds thereof in the ultraviolet-curable resin composition for a multilayer optical disc of the present invention at an arbitrary ratio.

The content of the urethane (meth)acrylate (A) is 5% by weight or more and less than 40% by weight, preferably 5 to 38% by weight and particularly preferably 10 to 35% by weight, based on the total amount of (A) and (B). The content of the urethane (meth)acrylate (A) based on the total amount of said resin composition is 5 to 38% by weight, preferably 5 to 35% by weight, more preferably 10 to 35% by weight and particularly preferably 15 to 35% by weight.

If the content of the urethane (meth)acrylate (A) is too high, the viscosity of said resin composition might be too high.

As the (meth)acrylate monomer (B) to be contained in the resin composition of the present invention, any known (meth)acrylate compound can be used without particular limitation. Specific examples of said (meth)acrylate monomer (B) include, for example, tricyclodecane (meth)acrylate, benzyl (meth)acrylate, dicyclopentanyl (meth)acrylate, dicyclopentenyloxyethyl (meth)acrylate, isobornyl (meth)acrylate, adamantyl (meth)acrylate, benzyl (meth)acrylate, tetrahydrofurfuryl (meth)acrylate, morpholine (meth)acrylate, isostearyl (meth)acrylate, neopentyl glycol di(meth)acrylate, tricyclodecanedimethylol di(meth)acrylate, hydroxypivalaldehyde-modified trimethylolpropane di(meth)acrylate, hydroxypivalic acid neopentyl glycol di(meth)acrylate, trimethylolpropane tri(meth)acrylate, pentaerythritol tri(meth)acrylate, dipentaerythritol penta(meth)acrylate and the like.

The (meth)acrylate monomer (B) to be used may be one kind of compound or a mixture of two or more kinds of compounds at an arbitrary ratio.

As said (meth)acrylate monomer (B), it is preferred to use a (meth)acrylate monomer having one or two (meth)acrylate groups in one molecule in order to improve detachability of a cured product of a resin composition from a transparent resin stamper.

Such a preferable (meth)acrylate monomer (B) can include, for example, at least one kind of compound selected from the group consisting of isobornyl (meth)acrylate, isostearyl (meth)acrylate, dicyclopentenyloxyethyl (meth)acrylate, neopentyl glycol di(meth)acrylate, tricyclodecanedimethanol di(meth)acrylate and hydroxypivalaldehyde-modified trimethylolpropane di(meth)acrylate. More preferably, the (meth)acrylate monomer (B) can include at least one kind (B-1) selected from the group consisting of isobornyl (meth)acrylate, tricyclodecanedimethanol di(meth)acrylate and hydroxypivalaldehyde-modified trimethylolpropane di(meth)acrylate.

In addition, in the present invention, an aspect in which one to three kinds of compounds among the above-described compounds are used in combination is one of preferable aspects.

Examples of this preferable aspect can include aspects of (i) to (vi) described below.
(i) An aspect in which one to three kinds of compounds selected from the group consisting of isobornyl (meth)acrylate, isostearyl (meth)acrylate, dicyclopentenyloxyethyl (meth)acrylate, neopentyl glycol di(meth)acrylate, tricyclodecanedimethanol di(meth)acrylate and hydroxypivalaldehyde-modified trimethylolpropane di(meth)acrylate are used in combination as the (meth)acrylate monomer (B). More preferably, an aspect in which one to three kinds of compounds selected from the group consisting of isobornyl (meth)acrylate, tricyclodecanedimethanol di(meth)acrylate and hydroxypivalaldehyde-modified trimethylolpropane di(meth)acrylate are used in combination.
(ii) An aspect in which, in the above-described (i), the above-described one to three kinds of compounds is 90 to 100% by weight based on the total amount of said (meth)acrylate monomer (B).
(iii) The aspect in the above-described (i) or (ii), in which at least one kind (B-1) selected from the group consisting of isobornyl (meth)acrylate, tricyclodecanedimethanol di(meth)acrylate and hydroxypivalaldehyde-modified trimethylolpropane di(meth)acrylate is contained as the (meth)acrylate monomer (B), the total content of the urethane (meth)acrylate (A) and said (B-1) component is 80 to 100% by weight based on the total amount of the (A) component and the (B) component, and the (B) component other than the (B-1) component is 0 to 20% by weight.
(iv) An aspect in which, in the above-described (iii), at least hydroxypivalaldehyde-modified trimethylolpropane di(meth)acrylate is contained as the (B-1) component.
(v) The aspect according to the above-described (iii) or (iv), in which at least isobornyl (meth)acrylate is contained as the (B-1) component.
(vi) The aspect according to any one of the above-described (iii) to (iv), in which at least tricyclodecanedimethanol di(meth)acrylate is contained as the (B-1) component.
(vii) The aspect according to any one of the above-described (i) to (vi), in which the total content of the urethane (meth)acrylate (A) and said (B-1) component is 90 to 100% by weight based on the total amount of the (A) component and the (B) component, and 0 to 10% by weight of the (meth)acrylate monomer (B) other than the (B-1) component is contained.
(viii) The aspect according to any one of the above-described (iii) to (vi), in which the (B) component other than the (B-1) component is dicyclopentenyloxyethyl (meth)acrylate.
(ix) The aspect according to the above-described (viii), in which 0 to 20% by weight of dicyclopentenyloxyethyl (meth)acrylate is contained based on the total amount of the (meth)acrylate monomer (B).

The content of said (meth)acrylate monomer (B) is 60 to 95% by weight, preferably 65 to 95% by weight and particularly preferably 65 to 90% by weight, based on the total amount of (A) and (B).

The content of the (meth)acrylate monomer (B) based on the total amount of said resin composition is 52 to 90% by weight, preferably 55 to 90% by weight, more preferably 55 to 85% by weight and further preferably 60 to 80% by weight.

The total content of the above urethane (meth)acrylate (A) and (meth)acrylate monomer (B) based on the total amount of said resin composition is preferably 90 to 99% by weight.

As the photopolymerization initiator (C) to be contained in the ultraviolet-curable resin composition for a multilayer optical disc of the present invention, any known radical photopolymerization initiator can be used without particular limitation. Said photopolymerization initiator (C) includes, for example, 1-hydroxycyclohexylphenyl ketone (IRGACURE 184; manufactured by CIBA Speciality Chemicals), 1-[4-(2-hydroxyethoxy)phenyl]-2-hydroxy-2-methylpropan-1-one (IRGACURE 2959; manufactured by CIBA Speciality Chemicals), 2-hydroxy-1-{4-[4-(2-hydroxy-2-methyl propionyl)benzyl]phenyl}-2-methylpropan-1-one (IRGACURE 127; manufactured by CIBA Speciality Chemicals), 2,2-dimethoxy-2-phenylacetophenone (IRGACURE 651; manufactured by CIBA Speciality Chemicals), oligo [2-hydroxy-2-methyl-1-[4-(1-methylvinyl)phenyl]propanone] (Esacure ONE; manufactured by Lamberti), 2-hydroxy-2-methyl-[4-(1-methylvinyl)phenyl]propanol oligomer (KIP-150; manufactured by Lamberti), 2-hydroxy-2-methyl-1-phenyl propan-1-one (DAROCUR 1173; manufactured by CIBA Speciality Chemicals), 2-methyl-1-[4-(methylthio)phenyl]-2-morpholinopropan-1-one (IRGACURE 907; manufactured by CIBA Speciality Chemicals), 2-benzyl-2-dimethylamino-1-(4-morpholinophenyl)butan-1-one, 2-chlorothioxanthone, 2,4-dimethylthioxanthone, 2,4-diisopropylthioxanthone, isopropylthioxanthone, 2,4,6-trimethylbenzoyl diphenyl phosphine oxide (Lucirin TPO: manufactured by BASF), bis(2,4,6-trimethylbenzoyl)phenyl phosphine oxide (IRGACURE 819; manufactured by CIBA Speciality Chemicals), bis(2,6-dimethoxy benzoyl)-2,4,4-trimethylpentylphosphine oxide and the like.

These photopolymerization initiators can be used alone or as a mixture of a plurality thereof at an arbitrary ratio.

The content of said photopolymerization initiator (C) is about 1 to 10% by weight and preferably about 3 to 8% by weight in said resin composition.

In addition, it is also possible to use a photopolymerization initiating auxiliary agent such as amines in combination with said photopolymerization initiator. Said photopolymerization initiating auxiliary agent includes, for example, diethanolamine, 2-dimethylaminoethylbenzoate, dimethylaminoacetophenone, p-dimethylaminobenzoic acid ethylester, p-dimethylaminobenzoic acid isoamylester and the like. When a photopolymerization initiating auxiliary agent is used in combination, the content thereof is preferably about 0.05 to 5% by weight and particularly preferably about 0.1 to 3% by weight in said resin composition.

The resin composition of the present invention may contain phosphoric acid (meth)acrylate as one of the (meth)acrylate monomers (B), if necessary.

Said phosphoric acid (meth)acrylate improves adhesiveness between aluminum, silver or a silver alloy used for a reflecting layer of an optical disc and an adhesive cured product but might corrode said metal film, so the use amount is limited. It is in the range of usually 0 to 10% by weight and preferably about 0 to 6% by weight based on the total amount of the (meth)acrylate monomer (B). In the present invention, there is usually no problem even when it is not contained.

Further, in the resin composition of the present invention, in addition to the above-described components, additives such as a silane coupling agent, a leveling agent, an antifoaming agent, a polymerization inhibitor, a light stabilizer (such as hindered amine-based ones), an antioxidant, an antistatic agent, a surface lubricant, a filler and the like may be used in combination, if necessary. Such an additive includes, for example, KBM-502, KBM-503, KBM-5103, KBM-802 and KBM-803 manufactured by Shin-Etsu Chemical Co., Ltd. and Z-6062, SH-6062 and SH-29PA manufactured by Toray Dow Corning Corporation as a silane coupling agent; BYK-333, BYK-307, BYK-3500, BYK-3530 and BYK-3570 manufactured by BYK Japan KK as a leveling agent; LA-82 manufactured by ADEKA Corporation as an antioxidant; and the like.

These may be added within the range of about 0 to 10% in terms of outer percentage, based on the total amount of the resin composition of the present invention. Therefore, the addition amount of these is not included in the total amount of the resin composition of the present invention in the present description.

The ultraviolet-curable resin composition for a multilayer optical disc of the present invention can be obtained by mixing and dissolving the above components at room temperature to 80° C., if necessary, followed by filtration.

The viscosity of said resin composition is 10 to 800 mPa·s, preferably 40 to 500 mPa·s, more preferably 50 to 400 mPa·s and further preferably 50 to 370 mPa·s, as a value measured at 25° C. by a B-type viscometer. In order to desirably form a cured product film of said resin composition to be used as an intermediate layer of an multilayer optical disc, it is preferred to adjust the viscosity of said resin composition in the above-described range.

By way of preferable examples of the resin composition of the present invention, the below-described resin compositions can be listed.
(I)

The ultraviolet-curable resin composition (hereinafter, referred to simply as resin composition) for a multilayer optical disc according to any one of (14) to (18) listed in the above “Means of Solving the Problems”, wherein the urethane (meth)acrylate (A) is the urethane (meth)acrylate according to any one of (i) to (v) listed as examples of the above preferable urethane (meth)acrylate.
(II)

The resin composition according to the above-described (I), wherein the (meth)acrylate monomer (B) is at least one kind selected from the group consisting of isobornyl (meth)acrylate, isostearyl (meth)acrylate, dicyclopentenyloxyethyl (meth)acrylate, neopentyl glycol di(meth)acrylate, tricyclodecanedimethanol di(meth)acrylate and hydroxypivalaldehyde-modified trimethylolpropane di(meth)acrylate.
(III)

The resin composition according to the above-described (I), wherein the (meth)acrylate monomer (B) is the aspect according to (i) listed as the above preferable aspect.
(IV)

The resin composition according to the above-described (I), wherein the (meth)acrylate monomer (B) is the aspect of (ii) listed as the above preferable aspect.
(V)

The resin composition according to the above-described (I), wherein the (meth)acrylate monomer (B) is the aspect of (iii) listed as the above preferable aspect.
(VI)

The resin composition according to the above-described (I), wherein the (meth)acrylate monomer (B) is the aspect of (iv) listed as the above preferable aspect.
(VII)

The resin composition according to the above-described (I), wherein the (meth)acrylate monomer (B) is the aspect of (v) listed as the above preferable aspect.
(VIII)

The resin composition according to the above-described (I), wherein the (meth)acrylate monomer (B) is the aspect of (vi) listed as the above preferable aspect.
(IX)

The resin composition according to the above-described (I), wherein the (meth)acrylate monomer (B) is the aspect of (vii) listed as the above preferable aspect.
(X)

The resin composition according to the above-described (I), wherein the (meth)acrylate monomer (B) is the aspect of (viii) listed as the above preferable aspect.
(XI)

The resin composition according to the above-described (I), wherein the (meth)acrylate monomer (B) is the aspect of (ix) listed as the above preferable aspect.
(XII)

The resin composition according to any one of the above-described (I) to (XI), wherein the content of the (A) component is 5 to 38% by weight based on the total amount of the (A) component and the (B) component, and the rest is the (B) component.
(XIII)

The resin composition according to the above-described (XII), wherein the content of the (A) component is 5 to 35% by weight based on the total amount of the (A) component and the (B) component.
(XIV)

The resin composition according to any one of the above-described (I) to (XIII), wherein the (A) component is 5 to 38% by weight, the (B) component is 52 to 85% by weight, and the (C) component is 1 to 10% by weight, based on the total amount of the resin composition.
(XV)

The resin composition according to any one of the above-described (I) to (XIV), wherein the (A) component is 5 to 35% by weight, the (B) component is 55 to 90% by weight, and (C) component is 1 to 10% by weight, based on the total amount of the resin composition.
(XVI)

The resin composition according to any one of the above-described (I) to (XV), wherein the total content of the (A) component and the (B) component is 90 to 99% based on the total amount of the resin composition.

The resin compositions of the present invention described above are suitable for forming a transparent intermediate layer of a multilayer optical disc.

The multilayer optical disc of the present invention is an optical disc characterized by having a cured product layer of the resin composition of the present invention described above, and can specifically include multilayer optical discs according to (1) to (11) listed in the above “Means of Solving the Problems”, multilayer optical discs having a cured product layer of the resin composition according to any one of the above-described (I) to (XVI), and the like.

The multilayer optical disc of the present invention described above can be obtained as described below.

The multilayer optical disc can be manufactured by the process in which:
(i) any one of the above-described resin compositions is directly coated either on a reflecting layer or a dielectric layer laminated on a transparent resin substrate or on a transparent resin stamper, the both are bonded, and then said resin composition is cured by irradiating ultraviolet rays to form an intermediate layer; or
(ii) the above-described resin composition is directly coated on a transparent resin stamper, subsequently said resin layer is cured by irradiating ultraviolet rays to said resin layer, and said cured product layer and a reflecting layer or a dielectric layer laminated on a transparent resin substrate are bonded via an adhesive layer to form an intermediate layer, and then, the transparent resin stamper is detached from the intermediate layer, a coloring matter layer and a reflecting layer, or a dielectric layer, as a second layer, is formed directly on the intermediate layer, a recording layer and a dielectric layer are further formed in the case of a dielectric layer, and according to necessity, a dummy substrate is bonded on the top of the second layer.

Formation methods of the intermediate layer in the case where the resin composition of the present invention is used as a transparent resin intermediate layer of a DVD having a plurality of recording layers will be specifically explained below.
(1) The resin composition of the present invention is coated at least either on a substrate where a first transparent resin substrate, a first recording layer and a first semitransparent reflecting layer are laminated in this order or on a transparent resin stamper by a spin coating method, a screen printing method, a roll coating method or the like, and then, said substrate and the transparent resin stamper are bonded and subsequently said resin composition is cured by irradiating active energy rays, for example, ultraviolet rays from the side of the transparent resin stamper to form a transparent resin intermediate layer.
(2) The resin composition of the present invention is coated on a transparent resin stamper by any of the methods described above, and then, said resin composition is cured by irradiating ultraviolet rays, a substrate where a first transparent resin substrate, a first recording layer and a first semitransparent reflecting layer are laminated and said transparent resin stamper are bonded via an adhesive layer comprising an arbitrary ultraviolet-curable resin so that the first semitransparent reflecting layer and the cured product layer of said resin composition face each other, and subsequently said adhesive layer is cured by ultraviolet rays or the like to form a transparent resin intermediate layer.

The formation method of the above-described (1) is preferred in terms that the production method can be shortened and thus the production cost is likely to be reduced. In addition, a transparent resin intermediate layer can be also formed for a Blu-ray disc having a plurality of recording layers in the same manner as described above.

Generally, a polycarbonate resin is used in a 0.6 mm first transparent resin substrate of DVD and in a 1.1 mm resin substrate of Blu-ray disc.

The transparent resin stamper includes, for example, an acrylic-based resin, a methacryl-based resin, a polycarbonate resin, a polyolefin-based resin (particularly amorphous polyolefin), a polyester resin, a polystyrene resin, an epoxy resin and the like. Among them, amorphous polyolefin is preferable in terms of detachability after curing a 2P resin, low moisture absorbency, shape stability and the like, and a polycarbonate resin is preferable in terms of material cost. The 2P curable resin composition of the present invention can be used for any of the transparent resin stampers.

The ultraviolet curable resin composition of the present invention gives a cured product by irradiating active energy rays. Said active energy rays include, for example, light rays of ultraviolet to near ultraviolet. The light source of said light ray includes, for example, low pressure mercury lamps, high pressure mercury lamps, ultrahigh pressure mercury lamps, metal halide lamps, (pulse) xenon lamps, electrodeless lamps, ultraviolet light-emitting diode and the like. Said cured product is also included in the present invention.

For a recording layer formed on the above transparent resin intermediate layer, both an organic coloring matter and a phase change material can be used. For example, the organic coloring matter includes metal-containing azo-based, polymethine-based and phthalocyanine-based ones, and the like, and the phase change material includes those in which one or more kinds of In, Ag, Au, Bi, Se, Al, P, Ge, Si, C, V, W, Ta, Zn, Ti, Ce, Tb, Sn and Pb are added to Sb or Te.

The multilayer optical discs such as DVDs and Blu-ray discs where a cured product of the resin composition of the present invention is used as a transparent resin intermediate layer are included in the present invention.

The coating method of the resin composition of the present invention includes, for example, a spin coating method, a 2P method, a roll coating method, a screen printing method and the like.

In addition, an about 400 nm blue laser is used for reading and/or writing in the next generation high density optical disc. Therefore, in the cured product of the resin composition of the present invention having a film thickness of 90-100 μm and preferably 100 μm, the light transmittance ratio at 405 nm wavelength is preferably 80% or more. It is more preferably 90% or more.

The transmittance ratio described in the table 1 described later is a value determined by measuring an absorbance value of said film at 405 nm using a spectrophotometer (U-3310, manufactured by Hitachi High-Technologies Corporation), after making a 100 μm cured film. As for the cured film of the resin composition of the present invention, the 100 μm cured film has a light transmittance ratio of 90% or more at 405 nm wavelength and is thus excellent and suitable for an optical disc using a blue laser.

### EXAMPLE

Hereinafter, the present invention will be specifically explained with reference to Examples.

### Synthesis Example 1

### Synthesis of Urethane Acrylate (A-1)

To a round-bottom flask equipped with a stirring device, a cooling tube and a thermometer, 51.0 parts by weight of isophorone diisocyanate, 55.9 parts by weight of 2-hydroxyethyl acrylate, 0.03 part by weight of methoquinone (polymerization inhibitor) and 0.05 part by weight of dibutyltin dilaurate (catalyst) were added, mixed at room temperature for 30 minutes, and then reacted at 80° C. for 5 hours. On completion of the reaction, the isocyanate concentration was confirmed to be 0.1% or less based on the reactant, and an intended urethane acrylate (A-1) to be used in the present invention was obtained.

The confirmation of the isocyanate concentration was carried out by dissolving the obtained reactant in toluene, adding dibutylamine to react with the isocyanate group, diluting with alcohol, and then titrating unreacted dibutylamine with hydrochloric acid.

### Synthesis Example 2

### Synthesis of Urethane Acrylate (A-2)

To a round-bottom flask equipped with a stirring device, a cooling tube and a thermometer, 52.5 parts by weight of isophorone diisocyanate, 71.4 parts by weight of 4-hydroxybutyl acrylate, 0.03 part by weight of methoquinone and 0.05 part by weight of dibutyltin dilaurate were added, mixed at room temperature for 30 minutes, and then reacted at 80° C. for 5 hours. In the same manner as in Synthesis Example 1, the isocyanate concentration was confirmed to be 0.1% or less based on the reactant, and an intended urethane acrylate (A-2) to be used in the present invention was obtained.

### Reference Synthesis Example 3

### Synthesis of Urethane Acrylate (A-3) for Comparison

To a round-bottom flask equipped with a stirring device, a cooling tube and a thermometer, 63 parts by weight of isophorone diisocyanate, 178.9 parts by weight of pentaerythritol triacrylate, 0.03 part by weight of methoquinone and 0.05 part by weight of dibutyltin dilaurate were added, mixed at room temperature for 30 minutes, and then reacted at 80° C. for 5 hours. In the same manner as in Synthesis Example 1, the isocyanate concentration was confirmed to be 0.1% or less based on the reactant, and an intended urethane acrylate (A-3) for Comparative Example was obtained.

### Reference Synthesis Example 4

### Synthesis of Urethane Acrylate (A-4) for Comparison

To a round-bottom flask equipped with a stirring device, a cooling tube and a thermometer, 14.8 parts by weight of hexamethylene diisocyanate, 95.1 parts by weight of dipentaerythritol pentaacrylate, 0.03 part by weight of methoquinone and 0.05 part by weight of dibutyltin dilaurate were added, mixed at room temperature for 30 minutes, and then reacted at 80° C. for 5 hours. In the same manner as in Synthesis Example 1, the isocyanate concentration was confirmed to be 0.1% or less based on the reactant, and an intended urethane acrylate (A-4) for Comparative Example was obtained.

### Reference Synthesis Example 5

### Synthesis of Urethane Acrylate (A-5) for Comparison

To a round-bottom flask equipped with a stirring device, a cooling tube and a thermometer, 77.3 parts by weight of polytetramethylene glycol (molecular weight: 2000) and 13.4 parts by weight of tolylene diisocyanate were added, and reacted at 80° C. for 10 hours until the isocyanate concentration was 3.57% or less based on the reactant. Subsequently, 9.2 parts by weight of 2-hydroxyethyl acrylate, 0.05 part by weight of methoquinone and 0.05 part by weight of dibutyltin dilaurate were added to said flask and reacted at 80° C. for 5 hours. In the same manner as in Synthesis Example 1, the isocyanate concentration was confirmed to be 0.1% or less based on the reactant, and an intended urethane acrylate (A-5) for Comparative Example was obtained.

### Examples 1-3, Comparative Examples 1-3 and Test Example

Each component of the constitutional materials in a use amount shown in the table 1 was mixed and resin compositions of Example 1-3 and Comparative Example 1-3 were prepared. The results from the evaluation of each obtained resin composition for the below-described items are shown in the table 1. And, “part(s)” in the table represents “part(s) by weight”.

In this regard, the value of viscosity described in the table 1 is a value measured at 25° C. using a B-type viscometer. In addition, the value of transmittance ratio described in the table 1 is a value measured by a spectrophotometer (product number: U-3310, manufactured by Hitachi High-Technologies Corporation) after making a cured film having a thickness of 100 μm.

TABLE 1

| | Exam- | Exam- | Exam- | Comp. | Comp. | Comp. |
|---|---|---|---|---|---|---|
| | ple 1 | ple 2 | ple 3 | Exam. 1 | Exam. 2 | Exam. 3 |
| Component | | | | | | |
| (A) (part(s)) | | | | | | |
| A-1 | 22 | | 27 | | | |
| A-2 | | 22 | | | | |
| A-3 | | | | 22 | | |
| A-4 | | | | | 22 | |
| A-5 | | | | | | 22 |
| Component | | | | | | |
| (B) (part(s)) | | | | | | |
| R-604 | 45 | 45 | | 45 | 45 | 45 |
| IBA | 23 | 23 | 63 | 23 | 23 | 23 |
| FA-512A | 5 | 5 | 5 | 5 | 5 | 5 |
| Component | | | | | | |
| (C) (part(s)) | | | | | | |
| KIP-150 | 5 | 5 | 5 | 5 | 5 | 5 |
| Detachability | | | | | | |
| Test | | | | | | |
| Detachment | 1.2 | 1.2 | 1.1 | 1.2 | 1.3 | Unde- |
| Strength (kgf) | | | | | | tach- |
| | | | | | | able |
| Detachability | ◯ | ◯ | ◯ | ◯ | ◯ | X |
| Judgment | | | | | | |
| Warp Test | | | | | | |
| Warping | −0.26 | −0.27 | −0.04 | −0.49 | −0.56 | −0.24 |
| (degree) | | | | | | |
| Warping | ◯ | ◯ | ◯ | X | X | ◯ |
| Judgment | | | | | | |
| Durability | | | | | | |
| Test | | | | | | |
| Warping | 0.02 | −0.24 | −0.1 | −0.54 | −0.53 | −0.20 |
| (degree) | | | | | | |
| Durability | ◯ | ◯ | ◯ | X | X | ◯ |
| Judgment | | | | | | |
| Transmittance | | | | | | |
| Ratio | | | | | | |
| %/405 nm | 92 | 92 | 92 | 92 | 92 | 92 |
| Viscosity | | | | | | |
| MPa · s | 340 | 350 | 60 | 290 | 250 | 430 |

Note:
“Comp. Exam.” in the table 1 means “Comparative Example”.

The components shown in abbreviation in the table 1 are as follows.
A-1: Urethane acrylate obtained in Synthesis Example 1
A-2: Urethane acrylate obtained in Synthesis Example 2
A-3: Urethane acrylate obtained in Reference Synthesis Example 3
A-4: Urethane acrylate obtained in Reference Synthesis Example 4
A-5: Urethane acrylate obtained in Reference Synthesis Example 5
R-604: Hydroxypivalaldehyde-modified trimethylolpropane diacrylate, manufactured by Nippon Kayaku Co., Ltd.
IBA: Isobornyl acrylate, manufactured by Osaka Organic Chemical Industry Ltd.
FA-512A: Dicyclopentenyloxyethyl acrylate, manufactured by Hitachi Chemical Co., Ltd.
KIP-150: 2-Hydroxy-2-methyl-[4-(1-methylvinyl)phenyl]propanol oligomer, manufactured by Lamberti SPA (photopolymerization initiator).

### (a) Detachability Test

### (Making a Sample Disc for Detachability Test)

Using each ultraviolet-curable resin composition obtained described above, each sample disc for detachability test was made by the method comprising the following steps 1 to 3.
1. On a substrate made of polycarbonate (first substrate) having a diameter of 120 mm and a thickness of 1.1 mm on which an azo-based coloring matter layer as a recording layer, a reflecting layer and a ZnS.SiO₂ layer as a dielectric layer had been formed, an ultraviolet-curable resin composition was applied without bubbles in. Thereon, a transparent resin stamper made of polycarbonate having a diameter of 120 mm and a thickness of 0.6 mm was put and spin coating was carried out at 2000 rpm for 4 seconds to bond the first substrate and said transparent resin stamper via the ultraviolet-curable resin composition.
2. Using a high pressure mercury lamp (80 W/cm), irradiation from the transparent resin stamper side was carried out in an integrated light amount of 400 mJ/cm² to cure the ultraviolet-curable resin composition.
3. Using a disc-detaching apparatus (manufactured by Origin Electric Co., Ltd.), said transparent resin stamper was detached from the cured product layer of said resin composition to make a sample disc for detachability test.

Using a disc-detaching apparatus (manufactured by Origin Electric Co., Ltd.) and a measuring instrument (FGC-5B, manufactured by Nidec-Shimpo Corporation), detachment strength of a sample disc from a transparent resin stamper made of polycarbonate was measured when the above-described sample disc (having diameter of 120 mm and internal diameter of 60 mm) for evaluation was made.

Judgment of detachability was carried out in accordance with the below-described criteria.

O . . . Detachment strength is less than 1.5 kgf.

× . . . Detachment strength is 1.5 kgf or more.

The results of detachment strength and detachability judgment of each sample disc obtained from the resin compositions in Examples 1 to 3 and Comparative Examples 1 to 3 are shown in the table 1.

### (b) Warp Test

On a substrate made of polycarbonate (first substrate) having a diameter of 120 mm, and a thickness of 1.1 mm on which an azo-based coloring matter layer as a recording layer and a ZnS.SiO₂ layer as a reflecting layer or a dielectric layer had been formed, each resin composition obtained above was coated by a spin coater so that the film thickness was 10±3 μm after curing. The coated film was irradiated with a high pressure mercury lamp (80 W/cm) in an integrated light amount of 400 mJ/cm² to make an optical disc for evaluation in warp test. A warp value of the transparent resin layer in the obtained optical disc was measured using MT-146 (manufactured by Dr. Schenk) which is an optical disc tester for physical properties. The warp value is larger with distance from the center of the disc, so the warp value (angle) of the region 56 mm from the center of the disc which is close to the most outer periphery was evaluated.

The warp variation in curing was calculated from the below-described (Mathematical Formula 1) and evaluated in accordance with the below-described criteria.

Warp variation (degree) in curing=disc warping (degree) after curing the coated film of the ultraviolet-curable resin composition−disc warping (degree) before coating the ultraviolet-curable resin composition (Mathematical Formula 1)

The warping unit is degree.

### (Warping Evaluation Criteria)

O . . . Warp variation before and after curing is less than ±0.3 degree.

× . . . Warp variation before and after curing is ±0.3 degree or more.

The results of warp variation before and after curing and warping judgment on each sample disc obtained from the resin compositions in Examples 1 to 3 and Comparative Examples 1 to 3 are shown in the table 1. In this regard, the warp variation is simply shown in “warping (degree)” in the item column of the table 1.

### (c) Durability Test

In durability test, each sample disc made in the process for the above-described warp test was left under conditions of high temperature and high humidity of 80° C. and 85% (relative humidity) for 96 hours, and then it was further stored for 24 hours at room temperature (25° C., 50%). The warp angle was measured before the test (before being placed under high temperature and high humidity) and after being stored at room temperature, a variation of the warp angle before and after the test was calculated. The warp value is larger with distance from the center of the disc, so the warp value of the region 56 mm from the center of the disc which is close to the most outer periphery was evaluated. In addition, for measurement, MT-146 (manufactured by Dr. Schenk) which is a mechanical property measuring device for optical discs was used.

The variation between the warp after durability test and the initial warp was calculated from the below-described (Mathematical Formula 2) and evaluated in accordance with the below-described criteria.

Warp variation (degree) before and after durability test=disc warping (degree) after durability test−disc warping (degree) before durability test (Mathematical Formula 2)

### (Warping Evaluation Criteria)

O . . . Warp variation before and after durability test is ±less than 0.3 degree.

× . . . Warp variation before and after durability test is ±0.3 degree or more.

The results of warp variation before and after durability test and durability judgment on each sample disc obtained from the resin compositions in Examples 1 to 3 and Comparative Examples 1 to 3 are shown in the table 1.

The transmittance ratio and the viscosity of each resin composition in Examples 1 to 3 and Comparative Examples 1 to 3 were measured by the above method.

As is clear from the table 1, the result is that the optical discs of Examples 1 to 3 obtained by curing the ultraviolet-curable resin composition of the present invention allow excellent detachability of a stamper made of polycarbonate from a cured film of a resin composition compared with Comparative Example 3.

In addition, the ultraviolet-curable resin compositions of Examples 1 to 3 had a warp variation before and after curing of −0.04 to −0.27 degree in warp test. Further, they had a warp variation before and after durability test under conditions of high temperature and high humidity of 0.02 to −0.24 degree. Comparative Example 1 and Comparative Example 2 using an urethane acrylate having three or more acrylate groups allowed the same detachability of a transparent resin stamper as Examples, but they had a warp variation before and after curing of −0.49 and −0.56 degree and a warp variation before and after durability test of −0.54 and −0.53 degree, confirming that they had a larger variation in warp.

Furthermore, the viscosity of the ultraviolet-curable resin composition of the present invention is within the range of 50 to 400 mPa·s and thus it is a viscosity suitable for forming a resin layer. Moreover, the resin composition had a light transmittance ratio of more than 90% at 405 nm of the cured film thereof and thus it is also excellent in terms of light permeability.

### Example 4

Each component of the constitutional materials and the use amount thereof shown below was mixed to make a resin composition of Example 4.

| | |
|---|---|
| Urethane acrylate obtained in Synthesis | 22 parts by weight; |
| Example 1 (A-1) | |
| Isobornyl acrylate (IBA) | 28 parts by weight; |
| Tricyclodecanedimethanol di(meth)acrylate | 45 parts by weight; and |
| (R684) | |
| KIP-150 | 5 parts by weight. |

The obtained resin composition was evaluated for the below-described items in the same manner as in Example 1, resulting in that it had a detachment strength of 0.9 kgf, a warp variation ratio in warp test of 0.23 degree (judgment: O), a warp variation ratio before and after durability test of 0.18 degree (judgment: O), and a light transmittance ratio of 92% at 450 nm.

As is clear from the above, even though the ultraviolet-curable resin composition of the present invention is directly applied to a reflecting layer or a dielectric layer on a disc substrate and thereon a transparent resin stamper, particularly a stamper made of polycarbonate, is bonded, said resin composition has excellent detachability in detachment of said stamper from a cured product layer of said resin composition. Therefore, it allows a process of forming an adhesive layer to be omitted, and is a very useful resin composition which is also suitable for forming a transparent resin intermediate layer having a recess/protrusion pattern.

### INDUSTRIAL APPLICABILITY

The ultraviolet-curable resin composition of the present invention and a cured product thereof are excellent in detachability from a transparent resin stamper, and it is useful as a 2P agent having a smaller variation in warp in curing and after being placed under high temperature and high humidity. In addition, the ultraviolet-curable resin composition of the present invention can provide an ultraviolet-curable resin allowing formation of a transparent resin intermediate layer with one liquid thereof without an adhesive layer.

1. A multilayer optical disc having a cured product layer of an ultraviolet-curable resin composition containing an urethane (meth)acrylate (A) having one or two (meth)acrylate groups in one molecule obtained by reacting a monofunctional or bifunctional organic isocyanate (a) having a molecular weight of 350 or less with a mono(meth)acrylate (b) having a hydroxy group, a (meth)acrylate monomer (B) and a photopolymerization initiator (C), where the content of the (A) component is 5 to less than 40% by weight based on the total amount of the (A) component and the (B) component, and the rest is (B).

2. The multilayer optical disc according to claim 1, wherein the organic isocyanate (a) is at least one kind selected from the group consisting of a C6 to C10 alicyclic mono- or di-isocyanate, a C6 to C10 aromatic ring mono- or di-isocyanate, hexamethylene diisocyanate and a (meth)acryloyloxy C2 to C4 alkyl isocyanate.

3. The multilayer optical disc according to claim 1, wherein the organic isocyanate (a) is at least one kind selected from the group consisting of isophorone diisocyanate, hexamethylene diisocyanate and (meth)acryloyloxyethyl isocyanate.

4. The multilayer optical disc according to claim 1, wherein the mono(meth)acrylate (b) having a hydroxy group is at least one kind selected from the group consisting of hydroxyethyl (meth)acrylate, hydroxypropyl (meth)acrylate, hydroxybutyl (meth)acrylate, and (meth)acrylic acid adducts of polypropylene glycol diglycidyl ether or polyethylene glycol diglycidyl ether.

5. The multilayer optical disc according to claim 1, wherein the (meth)acrylate monomer (B) is a compound having one or two (meth)acrylate groups in one molecule.

6. The multilayer optical disc according to claim 5, wherein the (meth)acrylate monomer (B) is at least one kind selected from the group consisting of isobornyl (meth)acrylate, isostearyl (meth)acrylate, dicyclopentenyloxyethyl (meth)acrylate, neopentyl glycol di(meth)acrylate, propylene oxide-modified neopentyl glycol di(meth)acrylate, tricyclodecanedimethanol di(meth)acrylate and hydroxypivalaldehyde-modified trimethylolpropane di(meth)acrylate.

7. The multilayer optical disc according to claim 1, wherein the total content of the urethane (meth)acrylate (A) and the (meth)acrylate monomer (B) is 90 to 99% by weight and the content of the photopolymerization initiator (C) is 1 to 10% by weight, based on the total amount of the resin composition.

8. The multilayer optical disc according to claim 1, wherein 5 to 35% by weight of the urethane (meth)acrylate (A), 55 to 90% by weight of the (meth)acrylate monomer (B) and 1 to 10% by weight of the photopolymerization initiator (C) are contained based on the total amount of the resin composition.

9. The multilayer optical disc according to claim 1, wherein:
the organic isocyanate (a) is at least one kind selected from the group consisting of isophorone diisocyanate, hexamethylene diisocyanate and (meth)acryloyloxyethyl isocyanate;
the mono(meth)acrylate (b) having a hydroxy group is at least one kind selected from the group consisting of hydroxyethyl (meth)acrylate, hydroxypropyl (meth)acrylate and hydroxybutyl (meth)acrylate;
the (meth)acrylate monomer (B) is at least one kind selected from the group consisting of isobornyl (meth)acrylate, tricyclodecanedimethanol di(meth)acrylate, dicyclopentenyloxyethyl (meth)acrylate and hydroxypivalaldehyde-modified trimethylolpropane di(meth)acrylate; and
5 to 35% by weight of the urethane (meth)acrylate (A), 55 to 90% by weight of the (meth)acrylate monomer (B) and 1 to 10% by weight of the photopolymerization initiator (C) are contained based on the total amount of the resin composition.

10. The multilayer optical disc according to claim 1, wherein at least one kind (B-1) selected from the group consisting of isobornyl (meth)acrylate, tricyclodecanedimethanol di(meth)acrylate and hydroxypivalaldehyde-modified trimethylolpropane di(meth)acrylate is contained as the(meth)acrylate monomer (B), and the total content of the urethane (meth)acrylate (A) and said (B-1) component is 80 to 100% by weight based on the total amount of the (A) component and the (B) component.

11. The multilayer optical disc according to claim 1, wherein the cured product layer is an intermediate layer of the multilayer optical disc.

12. A method for manufacturing a multilayer optical disc, comprising a process in which:
(i) the resin composition according to claim 1 is directly coated either on a reflecting layer or a dielectric layer laminated on a transparent resin substrate or on a transparent resin stamper, the both are bonded, and then said resin composition is cured by irradiating ultraviolet rays to form an intermediate layer; or
(ii) the resin composition according to claim 1 is directly coated on a transparent resin stamper, subsequently said resin layer is cured by irradiating ultraviolet rays to said resin layer, said cured product layer and the reflecting layer or the dielectric layer laminated on the transparent resin substrate are bonded via an adhesive layer to form an intermediate layer;
and then the transparent resin stamper is detached from the intermediate layer, a coloring matter layer and a reflecting layer, or a dielectric layer, as a second layer, is directly formed on the intermediate layer, and in addition, a recording layer and a dielectric layer are formed in the case of a dielectric layer.

13. Use of the ultraviolet-curable resin composition according to claim 1 for forming an intermediate layer in a multilayer optical disc.

14. An ultraviolet-curable resin composition for a multilayer optical disc, wherein an urethane (meth)acrylate (A) having one or two (meth)acrylate groups in one molecule obtained by reacting a monofunctional or bifunctional organic isocyanate (a) having a molecular weight of 350 or less with a mono(meth)acrylate (b) having a hydroxy group, a (meth)acrylate monomer (B) and a photopolymerization initiator (C) are contained, and the content of (A) is 5 to less than 40% by weight based on the total amount of (A) and (B), and the rest is (B).

15. The ultraviolet-curable resin composition for a multilayer optical disc according to claim 14, wherein the (meth)acrylate monomer (B) is a compound having one or two (meth)acrylate groups in one molecule.

16. The ultraviolet-curable resin composition for a multilayer optical disc according to claim 15, wherein:
the organic isocyanate (a) is at least one kind selected from the group consisting of isophorone diisocyanate, hexamethylene diisocyanate and (meth)acryloyloxyethyl isocyanate;
the mono(meth)acrylate (b) having a hydroxy group is at least one kind selected from the group consisting of hydroxyethyl (meth)acrylate, hydroxypropyl (meth)acrylate and hydroxybutyl (meth)acrylate;
the (meth)acrylate monomer (B) is at least one kind selected from the group consisting of isobornyl (meth)acrylate, tricyclodecanedimethanol di(meth)acrylate, dicyclopentenyloxyethyl (meth)acrylate and hydroxypivalaldehyde-modified trimethylolpropane di(meth)acrylate; and
5 to 35% by weight of the urethane (meth)acrylate (A), 55 to 90% by weight of the (meth)acrylate monomer (B) and 1 to 10% by weight of the photopolymerization initiator (C) are contained based on the total amount of the resin composition.

17. The ultraviolet-curable resin composition for a multilayer optical disc according to claim 14, wherein at least one kind (B-1) selected from the group consisting of isobornyl (meth)acrylate, tricyclodecanedimethanol di(meth)acrylate and hydroxypivalaldehyde-modified trimethylolpropane di(meth)acrylate is contained as the (meth)acrylate monomer (B), and the total content of the urethane (meth)acrylate (A) and said (B-1) component is 80 to 100% by weight based on the total amount of the (A) component and the (B) component.

18. The ultraviolet-curable resin composition for a multilayer optical disc according to claim 17, wherein at least two kinds are contained as said (B-1) component, one kind is hydroxypivalaldehyde-modified trimethylolpropane di(meth)acrylate, and the total content of said two kinds is 90 to 100% by weight based on the total amount of the (meth)acrylate monomer (B).

19. A multilayer optical disc having a cured product layer of the ultraviolet-curable resin composition for a multilayer optical disc according to claim 18.
